(19) United States
(12) Patent Application Publication
(10) Pub. No.: US 2026/0152986 A1
(43) Pub. Date: Jun. 4, 2026

(54) SIDE DOOR POWER STOPS

(71) Applicant: Stabilus GmbH, Koblenz (DE)

(72) Inventors: Jason Barba, Detroit, MI (US); Jason Miller, St. Clair Shores, MI (US); Christian K. Barash, Shelby Township, MI (US); Jared R. Yarmuth, Waterford, MI (US); Danut Tabacaru, Commerce Township, MI (US); Steven McDougall, Bruce Township, MI (US); Attila Kelemen, Lasalle Ontario (CA)

(73) Assignee: Stabilus GmbH, Koblenz (DE)

(21) Appl. No.: 19/399,819

(22) Filed: Nov. 25, 2025

Related U.S. Application Data
(60) Provisional application No. 63/726,765, filed on Dec. 2, 2024.

(51) Int. Cl. E05F 5/00; B60J 5/06; E05F 15/662

(52) U.S. Cl. CPC E05F 5/003; B60J 5/06; E05F 15/662; E05Y 2201/21; E05Y 2201/246; E05Y 2201/702; E05Y 2900/531

(57) ABSTRACT

Disclosed is an electronically controlled braking device for stopping a vehicle door at an arbitrary position, the device having a motor unit and at least one spindle drive unit with a spindle that has or is connected to an engaging section configured to engage with a check strap, not being part of the braking device and connected to the vehicle door, in a manner such that, in an engagement state of the engaging section and the check strap, a displacement of the check strap relative to the engaging section of the braking device is prohibited in at least one direction of movement of the check strap, and that, in a release state of the engaging section and the check strap, a displacement of the check strap relative to the engaging section of the braking device is allowed in the directions of movement of the check strap.

### CROSS REFERENCE TO RELATED APPLICATION

This application is a non-provisional of and claims priority to U.S. Provisional Application No. 63/726,765, which was filed on Dec. 2, 2024, the entire contents of which are incorporated herein by this reference.

### FIELD

The present invention relates to an electronically controlled braking device for stopping a vehicle door at a specific position.

### BACKGROUND

In the prior art, a vehicle door is known that is hinged to a vehicle body such that the vehicle door can be moved relative to the vehicle body in order to open or close an opening in the vehicle body. A check strap is usually provided, wherein the check strap is connected to the vehicle body at one longitudinal end thereof and the other longitudinal end thereof is arranged inside the vehicle door. A ball pressure piece that is also arranged inside the vehicle door is engaging with the check strap such that a spring-loaded ball of the ball pressure piece is pressed into a recess of the check strap to hold the vehicle door at a predetermined position by virtue of an engagement force between the ball pressure piece and the check strap. However, this arrangement only allows holding the door at the predetermined position defined by a respective recess of the check strap.

To allow a holding of the vehicle door at any desired position of the vehicle door relative to the vehicle body, so-called “power doors” are known that actuate a displacement of the vehicle door relative to the vehicle body using a power drive unit comprising an electrical motor and a spindle drive unit, for example. However, on the one hand, these power drive units are more expensive than the mechanism of a manually actuated vehicle door, including the check strap and the ball pressure piece, and, on the other hand, when replacing the mechanism of a manually actuated door by a power drive unit, the mechanism of the manually actuated door has to be removed.

### SUMMARY

It is the object of the present invention to provide a braking device for stopping a vehicle door at an arbitrary position while using a series check strap.

This object is solved according to the present invention by an electronically controlled braking device for stopping a vehicle door at an arbitrary position, comprising
a motor unit configured to be electrically powered to output a torque at an output shaft of the motor unit, and
at least one spindle drive unit comprising a spindle having a spindle thread and a spindle nut having a spindle nut thread, wherein the spindle thread and the spindle nut thread are in meshing engagement, wherein the spindle drive unit is configured to be driven by the output shaft of the motor unit such that the spindle and the spindle nut are displaced relative to each other along a displacement axis,
wherein at least one of the spindle and the spindle nut is comprising or is connected to an engaging section configured to engage with a check strap, not being part of the braking device and connected to the vehicle door or the vehicle body, in a manner such that, in an engagement state of the engaging section and the check strap, a displacement of the check strap relative to the engaging section of the braking device is prohibited in at least one direction of movement of the check strap, and that, in a release state of the engaging section and the check strap, a displacement of the check strap relative to the engaging section of the braking device is allowed in the directions of movement of the check strap.

It shall be mentioned already at this point that the term “vehicle door” can refer to all kinds of vehicle doors, such as a door, a hood or a trunk lid, but, in particular, can refer to a side door of a vehicle hinged to a vehicle body of the vehicle such that the vehicle door can be displaced relative to the vehicle body in a pivotal movement around the hinge axis. Furthermore, the term “stopping a vehicle door at an arbitrary position” may, but not has to, include a holding of the vehicle door at a specific position by the braking device.

By activating the motor unit and, thus, the spindle drive unit, a movement of the vehicle door can be prohibited in any desired position of the vehicle door relative to the vehicle body by a breaking engagement of the engaging section with the check strap. Depending on the kind of engagement between the engaging section and the check strap, a movement of the vehicle door can be prohibited in the opening direction as well as in the closing direction, e.g. by a clamping force that is exerted by the engaging section onto the check strap, or can be prohibited in only one of the opening direction and the closing direction, in particular only in the opening direction, e.g. by an abutment of the engaging section against a surface of the check strap.

The electronically controlled braking device according to the present invention may be installed in the vehicle already in its production process or may be installed in the vehicle after its production is completed as a so-called “after market equipment”. When installing the electronically controlled braking device, a ball pressure piece of the mechanism of a manually actuated door (see description above) may be removed or may be kept in the vehicle and used in combination with the electronically controlled braking device according to the present invention.

In the electronically controlled braking device, the torque may be transmitted from the output shaft of the motor unit to the spindle drive unit via a gear unit. Using a gear unit allows a transmission ratio between the output shaft of the motor unit and the spindle drive unit such that a high rotational speed and low torque at the output shaft can be transmitted into a lower rotational speed and higher torque at the spindle drive unit. Furthermore, a gear unit may allow a non-parallel or non-coaxial arrangement of a spindle axis of the spindle of the spindle drive unit relative to an axis of the output shaft of the motor drive unit.

In an embodiment of the electronically controlled braking device, the gear unit may comprise a worm and at least one worm gear. The worm and the at least one worm gear are in meshing engagement to transmit a rotational force from the worm to the worm gear, or vice versa.

In particular, the worm may be connected to the output shaft of the motor unit and each worm gear may be in meshing engagement with the worm. For example, the worm may be shrunk onto the output shaft of the motor unit or may be formed integrally with the output shaft of the motor unit. The worm gear is connected to the spindle or the spindle nut of the spindle drive unit such that a rotation of the worm gear driven by the worm is actuating the spindle drive unit.

In an embodiment of the present invention, the engaging section may comprise a first brake pad arranged on a sleeve being connected to the spindle nut or on an end of the spindle opposite to the output shaft of the motor unit. Here, an activation of the spindle drive unit displaces the first brake pad in the direction of the check strap or away from it. When displacing the first brake pad in the direction of the check strap such that the first brake pad comes into contact with the check strap, a pressing force can be exerted by the first brake pad onto the check strap resulting in a braking force capable of prohibiting a movement of the check strap relative to the first brake pad up to the amount of the braking force. When moving the first brake pad away from the check strap by a corresponding activation of the spindle drive unit, the braking force is removed and the check strap is released to move freely relative to the first brake pad along its given path of movement when opening or closing the vehicle door.

Optionally, a second brake pad may be arranged on a side of the check strap opposite to the side at which the first brake pad is configured to contact the check strap such that a support for the check strap is provided when the first brake pad is exerting a pressing force onto the check strap. Thus, the second brake pad may ensure that the check strap is not only pushed away by the first brake pad but an actual braking force in the desired amount is exerted by the first brake pad onto the check strap. When the first brake pad and the second brake pad both engage with the check strap, together they exert a clamping force onto the check strap. The second brake pad may, for example, be connected to the vehicle door or, in a case where the braking device is mounted at the vehicle body, the second brake pad can be connected to the vehicle body, or the second brake pad may be connected to a base or a housing of the braking device in relation to which the first brake pad is translatable.

In addition to that, the braking device may comprise a further spindle drive unit, wherein the further spindle drive unit may also be driven by the motor unit, and wherein the second brake pad may be connected to the further spindle drive unit. The use of the further spindle unit to not only press the first brake pad against the check strap and to press, in a passive manner, the check strap against the second brake pad but to actively press the first brake pad onto the check strap from one side and, at the same time, actively press the second brake pad onto the check strap from another side, in particular the side of the check strap being opposite to the side of the check strap that comes into contact with the first brake pad. Doing so, the first brake pad and the second brake pad may exert a braking force onto the check strap at substantially the same time. Also, the first brake pad and the second brake pad can be displaced away from the check strap such that there is no contact and, hence, no undesired frictional force between the check strap and a brake pad, in particular the second brake pad, in the released state of the engaging section and the check strap.

To facilitate the transmission of torque from the output shaft of the motor unit to the spindle drive unit and the further spindle drive unit, the braking device may comprise a dual worm gear unit comprising one worm and two worm gears, wherein the worm gears may be arranged on diametrically opposite sides of the worm. This arrangement needs very little space for the gear unit. When arranging the worm gear of the spindle drive unit and the worm gear of the further spindle drive unit on diametrically opposite sides of the worm, it can also be realized in a very simple manner that, due to a rotation of the worm, the first brake pad and the second brake pad move into opposite directions in order to engage with the check strap or release the check strap.

In addition or as an alternative, the check strap may have a longitudinal end connected to the vehicle body and a free longitudinal end, wherein the engaging section may be configured to abut against a surface of the check strap in the vicinity of the free end of the check strap.

By only abutting against a surface of the check strap, a movement of the vehicle door may only be prohibited in one direction, in particular in the opening direction of the vehicle door relative to the vehicle body. In an exemplary case, in which the vehicle is parked on a lateral slope such that the left side of the vehicle is facing downwards and the right side of the vehicle is facing upwards the slope, and the driver of the vehicle (sitting on the left side of the vehicle in this case) is opening the vehicle door from inside the vehicle, the electronically controlled braking device may be configured to restrict a sudden and uncontrolled full opening of the vehicle door by displacing the engaging section to a predetermined position at which the surface of the check strap abuts against the engaging section and a further opening of the door is prohibited. Therefore, it can be avoided that the door hits an obstacle and gets damaged or damages the obstacle. It is also conceivable in this regard that, after the surface of the check strap abuts against the engaging section of the braking device, the braking device is actuating the spindle drive unit such that the engaging section and the check strap abutting against it are displaced at a predetermined speed resulting in an opening of the door due to gravitational forces in a controlled manner.

To realize the above-described controlled opening of the vehicle door, the surface may be facing to the longitudinal end of the check strap that is connected to the vehicle body.

The braking device may comprise an electronical brake unit being installed in a force transmission path between the motor unit and the spindle or the spindle nut to stop and hold the spindle or the spindle nut at a predetermined position such that a displacement of the spindle nut relative to the spindle is prohibited. By prohibiting a displacement of the spindle nut relative to the spindle, a displacement of the check strap relative to the engaging section of the braking device may be prohibited in at least the direction in which the engaging section abuts against the surface of the check strap. In particular, the electronical brake unit can provide for braking forces having a significantly higher amount of braking force than the amount of a braking force that can be provided by a braking device without an electronical brake unit due to its self-locking properties of the spindle drive unit and the motor unit, and the gear unit, if present. The electronical brake unit may be adjusted gradually in its exerted braking force such that a movement of the spindle nut relative to the spindle may be slowed down but not fully stopped.

The electronically controlled braking device may comprise a limit switch that is configured to be switched by the spindle nut or the sleeve or the spindle. The limit switch may be located at the end of the spindle drive unit near the gear unit such that the limit switch comes into contact with the spindle nut or the sleeve or the spindle when it is retracted. Upon a change of state of the limit switch, the limit switch may output a signal, e.g. to a control unit, such that the actuation of the spindle drive unit is stopped, e.g. by deactivating the motor unit. It can, thus, be prevented that the spindle nut or the sleeve or the spindle is retracted beyond a predetermined position of a fully retracted state of the electronically controlled braking device.

Advantageously, the braking device may comprise a position determination unit configured to determine a relative position of the spindle and the spindle nut along an axis of displacement of the spindle nut relative to the spindle. In particular, in relation to a stopping of the vehicle door in only one of its directions of movement, but not limited to it, the determination of the actual relative position of the spindle nut and the spindle allows an even more accurate stopping of the vehicle door at a predetermined position. In relation to the use of a brake pad with the electronically braking device for stopping the vehicle door, the actual relative position of the spindle and the spindle nut, e.g. in combination with a determination of the actual braking force, may be used to determine wear of the at least one brake pad.

In an embodiment of the present invention, the position determination unit may comprise at least one of a hall sensor unit and a linear position sensor unit. The linear position sensor unit may, in turn, at least one of inductive measurement means, optical measurement means and capacitive measurement means. It shall be mentioned that the above-mentioned embodiments of the position determination unit and of the linear position sensor unit are mere examples and other embodiments may be implemented that provide the functionality of determining a relative position of the spindle and the spindle nut along an axis of displacement of the spindle nut relative to the spindle.

### BRIEF DESCRIPTION OF THE DRAWINGS

In the following, the present invention is described in greater detail using embodiments of the present invention with reference to the accompanying drawings.

FIG. 1 shows a first embodiment of the electronically controlled braking device according to the present invention in an engaged state;

FIG. 2 shows the braking device according to FIG. 1 in its released state;

FIG. 3 shows a second embodiment of the electronically controlled braking device according to the present invention in its engaged state;

FIG. 4 shows the braking device according to FIG. 3 in its released state; and

FIG. 5 shows a third embodiment of the electronically controlled braking device according to the present invention.

### DETAILED DESCRIPTION

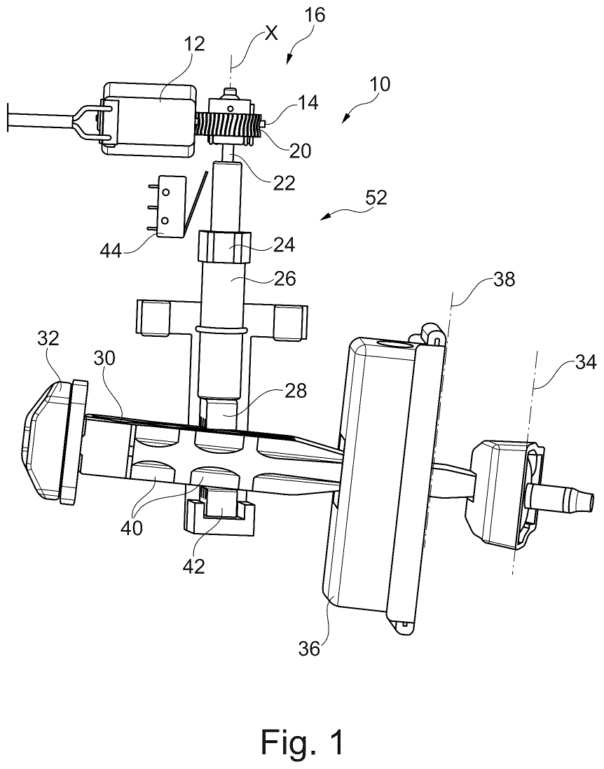

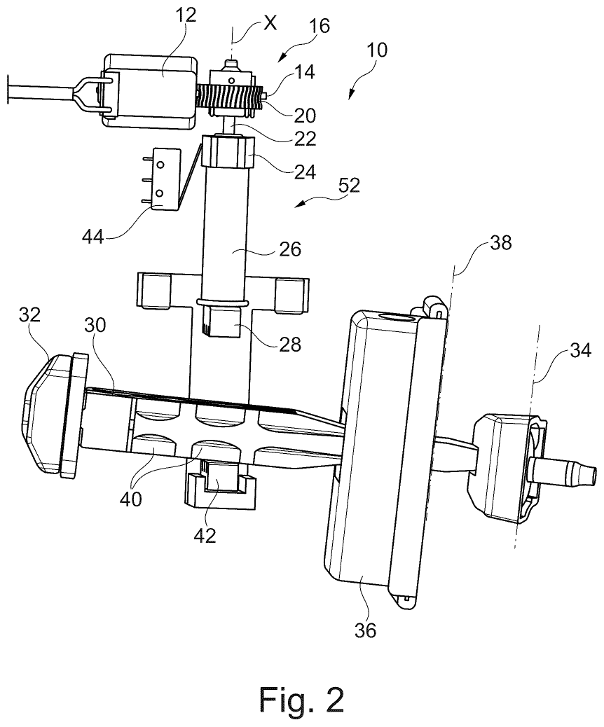

In FIGS. 1 and 2, an electronically controlled braking device according to the present invention is shown that is generally denoted with the reference numeral 10. The braking device 10 comprises a motor unit 12 which, in the shown embodiment, comprises a DC motor. The motor unit 12 drives an output shaft 14. The output shaft 14 of the motor unit 12 is in torque-transmitting engagement with a gear unit 16.

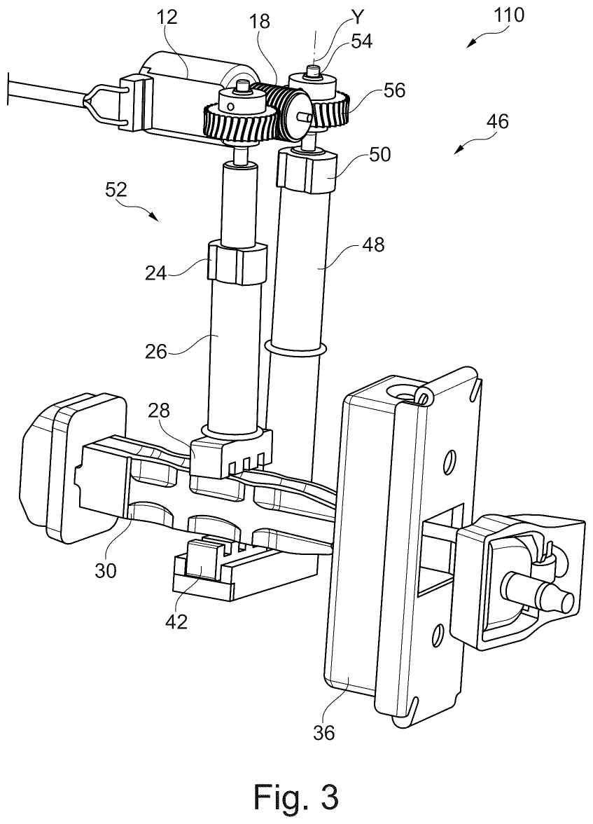

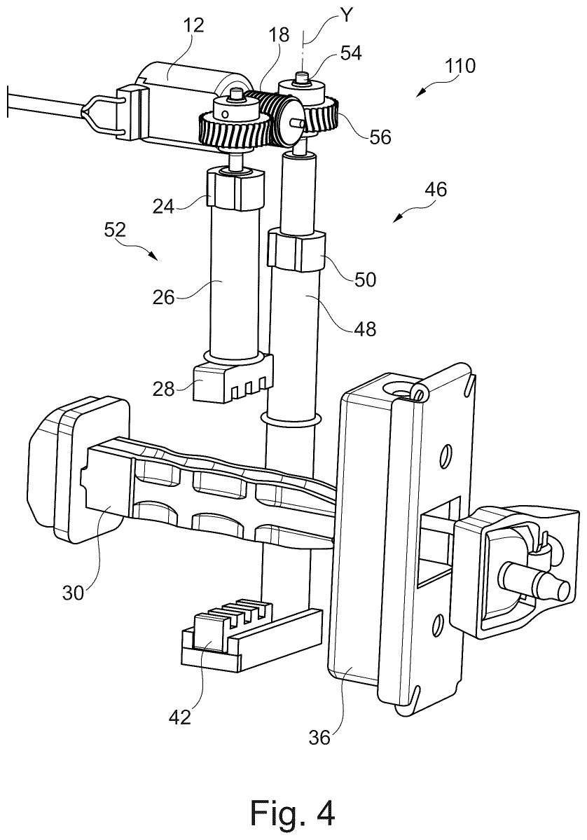

With additional reference to the perspective view of FIGS. 3 and 4, the gear unit 16 comprises a worm 18 that is attached to or is part of the output shaft 14. The worm 18 meshes with a worm gear 20 such that torque from the output shaft 14 is transmitted to the worm gear 20.

The worm gear 20 is connected to a spindle 22 having an outer spindle thread. A spindle nut 24 having an inner spindle nut thread is meshing with the spindle thread in a manner such that a rotation of the spindle around a spindle axis X results in a translation of the spindle nut along the spindle axis X. A sleeve 26 is attached to the spindle nut 24. On the longitudinal side of the sleeve 26 that is opposite to the longitudinal end of the sleeve 26 at which it is connected to the spindle nut 24, a first brake pad 28 is attached to the sleeve 26.

Furthermore, FIGS. 1 and 2 show a check strap 30 having a free longitudinal end 32. At its longitudinal end being opposite to the free end 32, the check strap 30 is attached to a vehicle body 34 (indicated by a dotted line). The check strap 30 passes through a ball pressure piece 36 that is attached to an inside of a vehicle door 38 (indicated by a dotted line). The ball pressure piece 36 is configured to press at least one ball, e.g. by virtue of a spring, against the check strap 30. When a relative position of the check strap 30 to the ball pressure piece 36 is such that a recess 40 present at the check strap 30 is aligned with the at least one ball of the ball pressure piece 36, the at least one ball of the ball pressure piece 36 is engaging with the recess 40, wherein, depending on the properties of the ball pressure mechanism 36, a holding force is generated holding the vehicle door 38 at the specific position up to the amount of the holding force.

As it becomes clear from the above description of the mechanism of the ball pressure piece 36, the ball pressure piece 36 is only capable of holding the vehicle door 38 at very distinct and few positions of the vehicle door 38 relative to the vehicle body 34.

Now, by providing the vehicle with the electronically controlled braking device 10 according to the present invention, it is possible to activate the motor unit 12 in a way that the first brake pad 28 is translated towards the check strap 30 until it contacts the check strap 30 and exerts a predetermined braking force to prevent a movement of the check strap 30 relative to the first brake pad 28 up to the amount of the braking force. As can be seen, this holding of the check strap 30, and therewith of the vehicle door 38, by the first brake pad 28 can be engaged at any desired position of the check strap 30 relative to the first brake pad 28, and thus at any desired position of the vehicle door 38 relative to the vehicle body 34.

To prevent that the first brake pad 28 is pushing the check strap 30 away by bending it, rather than applying and increasing a braking force onto it, a support in the form of a second brake pad 42 is provided at a side of the check strap 30 that is opposite to the side of the check strap 30 engaging with the first brake pad 28. In the embodiment of FIGS. 1 and 2, the second brake pad 42 is arranged relatively fixed to the vehicle door 38.

As also shown in FIGS. 1 and 2, the electronically controlled braking device 10 according to the present invention may comprise a limit switch 44. The limit switch 44 is configured and arranged in a way that its state changes in dependency of the spindle nut 24 or sleeve 26 being present in the vicinity of the limit switch 44, e.g. in contact with the limit switch 44, or not. Doing so, it can be prevented that the spindle nut 24 or the sleeve 26 are retracted beyond a predetermined position of a fully retracted state of the electronically controlled braking device 10, as it is shown in FIG. 2.

FIGS. 3 and 4 show a second embodiment of the electronically controlled braking device according to the present invention which is generally denoted by reference numeral 110. In most parts, the second embodiment of the braking device 110 is identical to the first embodiment of the braking device 10 such that it is explicitly referred to the corresponding description given above. In the following only the differences between the first embodiment 10 and the second embodiment 110 are described. Identical components are denoted with identical reference numerals. Analogue components are denoted with a reference numeral increased by the number 100 compared to the first embodiment 10.

Instead of providing a fixed second brake pad 42, as it is done in the first embodiment of the braking device 10, in the second embodiment of the braking device 110, also the second brake pad 42 is capable of actively exerting a braking force onto the check strap 30. For this purpose, the second brake pad 42 is displaceable via the electric motor unit 12 by a further spindle drive unit 46. In the embodiment shown in FIGS. 3 and 4, the second brake pad 42 is attached to a second sleeve 48 of the further spindle drive unit 46 that, in turn, is connected to a second spindle nut 50 of the further spindle drive unit 46. In an analogue manner to the first spindle drive unit 52, comprising the spindle 22, the spindle nut 24, and the sleeve 26, the second spindle nut 50, the second sleeve 48, and the second brake pad 42 are translatable along a spindle axis Y of a second spindle 54 of the further spindle drive unit 46. The second spindle 54 is in torque-transmitting engagement with a second worm gear 56 that meshes with the worm 18.

When the motor unit 12 is activated, the worm gear 20 and the second worm gear 56 are driven in opposite rotational directions. That is, depending on the rotational direction of the worm 18, the first brake pad 28 and the second brake pad 42 are either both displaced toward the check strap 30 in order to engage with it and to apply a predetermined braking force onto it or the first brake pad 28 and the second brake pad 42 are retracted from the check strap 30 such that now braking force is applied by the first brake pad 28 and the second brake pad 42 onto the check strap 30 and the check strap 30 is free to move relative to the braking device 110.

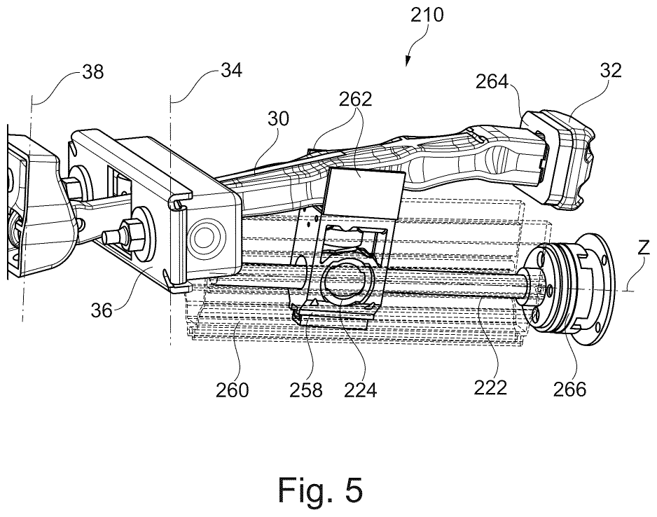

FIG. 5 shows a third embodiment of the electronically controlled braking device according to the present invention which is denoted by reference numeral 210. Analogue to the description of the second embodiment of the braking device 110, also the braking device 210 is only described in view of its differences to the first and second embodiments, wherein analogue components are denoted with analogue reference numerals in the number group of the 200s.

The braking device 210 comprises a spindle 222 that meshes with a spindle nut 224. When the spindle 222 is rotated by a motor unit 12 (not shown in FIG. 5), the spindle nut 224 and a sliding element 258 attached to the spindle nut 224 is translated along a spindle axis Z. The sliding element 258 is guided in a guide rail 260 surrounding the sliding element 258, the spindle nut 224, and the spindle 222 at least in part.

The sliding element 258 is provided with (in this embodiment two) protrusions 262 protruding out of the guide rail 260. The protrusions 262 are configured to engage with a surface 264 arranged in the vicinity of the free end 32 of the check strap 30.

As can be seen in FIG. 5, the vehicle door 38 is in a fully or almost closed position relative to the vehicle body 34. Also, the surface 264 of the check strap 30 is not in contact with the protrusions 262. Therefore, the vehicle door 38 can be opened freely until the surface 264 abuts against the protrusions 262 of the braking device 210. As soon as the protrusions 262 contact the surface 264, a further opening of the vehicle door 38 is prohibited by the braking device 210.

To increase a stopping force of the braking device 210 against an unintentional further movement of the vehicle door 38, the braking device 210 is provided with an electronical brake unit 266 that is configured to be opened and closed electronically, i.e. based on an according control signal. It is understood, that the electronical brake unit 266 may also be opened or closed gradually such that the locking force of the electronical brake unit 266 may be gradually adjusted.

1. Electronically controlled braking device for stopping a vehicle door at an arbitrary position, comprising:
a motor unit configured to be electrically powered to output a torque at an output shaft of the motor unit; and
at least one spindle drive unit comprising a spindle having a spindle thread and a spindle nut having a spindle nut thread, wherein the spindle thread and the spindle nut thread are in meshing engagement, wherein the spindle drive unit is configured to be driven by the output shaft of the motor unit such that the spindle and the spindle nut are displaced relative to each other along a displacement axis,
wherein at least one of the spindle and the spindle nut is comprising or is connected to an engaging section configured to engage with a check strap, not being part of the braking device and connected to the vehicle door or the vehicle body, in a manner such that, in an engagement state of the engaging section and the check strap, a displacement of the check strap relative to the engaging section of the braking device is prohibited in at least one direction of movement of the check strap, and that, in a release state of the engaging section and the check strap, a displacement of the check strap relative to the engaging section of the braking device is allowed in the directions of movement of the check strap.

2. Electronically controlled braking device according to claim 1,
wherein the torque is transmitted from the output shaft of the motor unit to the spindle drive unit via a gear unit.

3. Electronically controlled braking device according to claim 2,
wherein the gear unit comprises a worm and at least one worm gear.

4. Electronically controlled braking device according to claim 3,
wherein the worm is connected to the output shaft of the motor unit and each worm gear is in meshing engagement with the worm.

5. Electronically controlled braking device according to claim 1,
wherein the engaging section comprises a first brake pad arranged on a sleeve being connected to the spindle nut or on an end of the spindle opposite to the output shaft of the motor unit.

6. Electronically controlled braking device according to claim 1,
wherein a second brake pad is arranged on a side of the check strap opposite to the side at which the first brake pad is configured to contact the check strap such that a support for the check strap is provided when the first brake pad is exerting a pressing force onto the check strap.

7. Electronically controlled braking device according to claim 6,
wherein the braking device comprises a further spindle drive unit,
wherein the further spindle drive unit is also driven by the motor unit, and
wherein the second brake pad is connected to the further spindle drive unit.

8. Electronically controlled braking device according to claim 7,
wherein the braking device comprises a dual worm gear unit comprising one worm and two worm gears, wherein the worm gears are arranged on diametrically opposite sides of the worm.

9. Electronically controlled braking device according to claim 1,
wherein the check strap has a longitudinal end connected to the vehicle body and a free longitudinal end, and
wherein the engaging section is configured to abut against a surface of the check strap in the vicinity of the free end of the check strap.

10. Electronically controlled braking device according to claim 9,
wherein the surface is facing to the longitudinal end of the check strap that is connected to the vehicle body.

11. Electronically controlled braking device according to claim 1,
wherein the braking device comprises an electronical brake unit being installed in a force transmission path between the motor unit and the spindle or the spindle nut to stop and hold the spindle or the spindle nut at a predetermined position such that a displacement of the spindle nut relative to the spindle is prohibited.

12. Electronically controlled braking device according to claim 1,
wherein the braking device comprises a position determination unit configured to determine a relative position of the spindle and the spindle nut along an axis of displacement of the spindle nut relative to the spindle.

13. Electronically controlled braking device according to claim 12,
wherein the position determination unit comprises at least one of a hall sensor unit and a linear position sensor unit.

14. Electronically controlled braking device according to claim 13,
wherein the linear position sensor unit comprises at least one of inductive measurement means, optical measurement means and capacitive measurement means.
